(19) United States
(12) Patent Application Publication
(10) Pub. No.: US 2017/0124753 A1
(43) Pub. Date: May 4, 2017

(54) PRODUCING CUT-OUT MESHES FOR GENERATING TEXTURE MAPS FOR THREE-DIMENSIONAL SURFACES

(71) Applicant: Electronic Arts Inc., Redwood City, CA (US)

(72) Inventor: Peter Arisman, Lake Mary, FL (US)

(21) Appl. No.: 14/931,392

(22) Filed: Nov. 3, 2015

(51) Int. Cl. G06T 15/04; G06T 17/20

(52) U.S. Cl. CPC G06T 15/04; G06T 17/20; G06T 2210/16

(57) ABSTRACT

A method of creating texture maps for three-dimensional surfaces may include receiving a polygonal mesh defining a shape of a three-dimensional object. The method may further include determining positions of points identifying a plurality of curves on a surface of the polygonal mesh. The method may further include producing a mesh cutout having a border defined by a closed loop line comprising the plurality of curves. The method may further include determining that a projection of the mesh cutout onto a flat surface produces a value of a visual distortion metric that does not exceed a defined distortion threshold. The method may further include creating a texture map by projecting a two-dimensional image onto a surface of the mesh cutout. The method may further include using the texture map to produce a visual representation of the three-dimensional object.

### TECHNICAL FIELD

The present disclosure is generally related to creating computer-generated imagery, and is more specifically related to creating texture maps for three-dimensional surfaces.

### BACKGROUND

In computer-generated visual content (such as interactive video games), various three-dimensional objects, such as human bodies, vehicles, etc., may be represented by polygonal meshes. A polygonal mesh herein shall refer to a collection of vertices, edges, and faces that define the shape and/or boundaries of a three-dimensional object. An edge is a line connecting two vertices. A vertex is a point having a certain spatial position. Mesh faces may be provided by various polygonal shapes such as triangles, quads (quadrangles), and/or other regular or irregular polygons.

For enhancing the visual resemblance of computer-generated three-dimensional objects with their respective real-life prototypes, various texture maps may be employed. A texture map herein shall refer to a projection of an image onto a three-dimensional surface (such as a surface represented by a polygonal mesh).

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 schematically illustrates an example processing workflow for creating texture maps for three-dimensional surfaces, in accordance with one or more aspects of the present disclosure;

FIG. 2 schematically illustrates elements of a sports uniform, for which various texture maps may be created by an example processing workflow operating in accordance with one or more aspects of the present disclosure;

FIG. 3 schematically illustrates a border of an example mesh cutout following the seam line of an item of a sports uniform, in accordance with one or more aspects of the present disclosure;

FIG. 4 schematically illustrates a flow diagram of an example method for creating texture maps for three-dimensional surfaces, in accordance with one or more aspects of the present disclosure;

FIG. 5 schematically illustrates a flow diagram of an example method for defining the border of a mesh cutout, in accordance with one or more aspects of the present disclosure;

FIG. 6 depicts a block diagram of an illustrative computing device operating in accordance with one or more aspects of the present disclosure.

### DETAILED DESCRIPTION

Described herein are methods and systems for creating texture maps for three-dimensional surfaces using polygonal mesh cutouts. Such methods and systems may be employed, for example, in various interactive video game applications for generating three-dimensional visual objects representing game characters equipped with recognizable sports uniforms of real-life sports teams.

In various illustrative examples, a polygonal mesh may be employed for defining a shape of a three-dimensional object, such as a part of a human body equipped with a sports uniform, a part of a motor vehicle body, or a part of a body armor. Various texture maps, such as an albedo map, a normal map and/or an occlusion map, may be employed for enhancing the visual resemblance of computer-generated three-dimensional objects to their respective real-life prototypes. In common implementations, such texture maps are created in a two-dimensional UV space, where the letters U and V denote the axes of such space. In an illustrative example, a texture map may be employed for creating a visual representation of a sports team logotype affixed to certain elements of the game character uniform. Since the texture maps are created in a two-dimensional space and then applied to a three-dimensional surface, the two-dimensional logotype image would have to be distorted in order to preserve the visual resemblance with the original after having been transferred onto three-dimensional surface of a polygonal mesh (e.g., in order to preserve the image aspect ratio). The necessary distortion of the two-dimensional image may introduce significant complexity into the image creation and subsequent edition.

Aspects of the present disclosure address the above noted and other deficiencies by providing systems and methods that employ specifically designed polygonal mesh cutouts for creating texture maps for three-dimensional surfaces. In accordance with one or more aspects of the present disclosure, an example workflow for creating texture maps for three-dimensional surfaces may identify mesh cutouts having undistorted (or minimally distorted) projections onto a flat surface. Various texture maps may then be produced by projecting undistorted two-dimensional images onto such mesh cutouts, as described in more details herein below.

An example workflow for creating texture maps for three-dimensional surfaces may define a border of a mesh cutout (e.g., using spline-based functions and/or Beziers curves). In certain implementations, the border of the mesh cutout may be chosen to follow a contour of a part of the real-life object that is simulated by the three-dimensional mesh. In an illustrative example, the border of the mesh cutout may be chosen to follow the seam line of an item of a sports uniform, thus simulating the process of cutting and sewing several pieces of fabric into the uniform. Since in the real life each piece of the fabric is flat before being sewed together with other pieces of fabric, the mesh cutout having a border following the seam line of a clothing item would have an undistorted flat surface projection.

In various illustrative examples, the identified mesh cutout may represent a panel, a patch, a stripe, and/or a stich of a sports uniform. Upon identifying the mesh cutout, the processing device implementing the method may create a texture map by projecting a two-dimensional image onto the identified mesh cutout, as described in more details herein below.

Various aspects of the above referenced methods and systems are described in details herein below by way of examples, rather than by way of limitation.

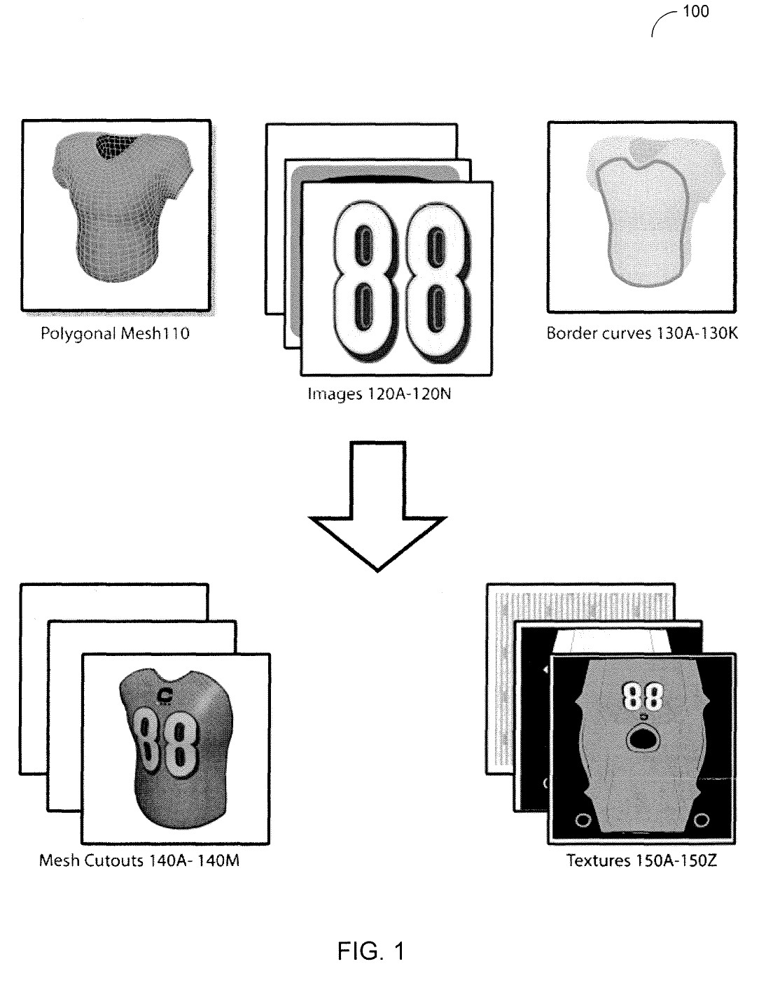

In accordance with one or more aspects of the present disclosure, generation of visual objects representing sports uniform items may be implemented as a fully-automated or artist-assisted workflow. As schematically illustrated by FIG. 1, example processing workflow 100 operating in accordance with one or more aspects of the present disclosure may receive an a polygonal mesh 110 that is compliant with the topology of a target application (such as an interactive computer videogame). In the illustrative example of FIG. 1, polygonal mesh 110 may represent the three-dimensional shape of one or more parts of a human body to be covered by the sports uniform. Alternatively, polygonal mesh 110 may represent various other three-dimensional objects for producing computer-generated visual content, such as parts of a motor vehicle body or parts or body armor.

Example processing workflow 100 may further receive one or more two-dimensional images 120A-120N to be employed for creating the texture maps. In an illustrative example, images 120A-120N may depict a sports team logotype.

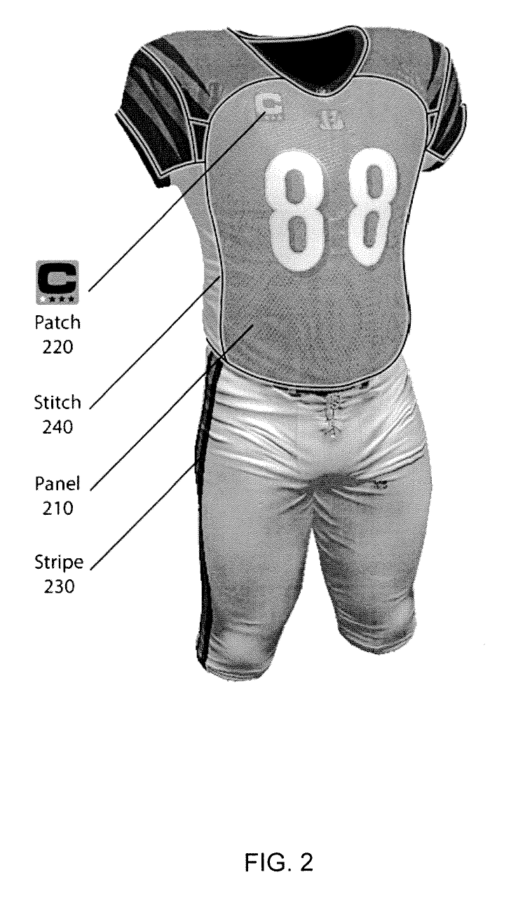

Example processing workflow 100 may then identify one or more border curves 130A-130K that define, on polygonal mesh 110, the borders of respective mesh cutouts. In an illustrative example, a mesh cutout may represent an element of the sports uniform. As schematically illustrated by FIG. 2, the uniform elements may include a panel 210, a patch 220, a stripe 230, and/or a stich 240 of a sports uniform.

In accordance with one or more aspects of the present disclosure, example processing workflow 100 may identify a border of a mesh cutout that has an undistorted or minimally distorted projection onto a flat surface (or, in other words, the flat surface projection having visual distortion not exceeding a certain distortion threshold).

The mesh cutout border may be defined using one or more spline-based parametric curves. “Spline” herein shall refer to a numeric function that is piecewise-defined by polynomial functions and possesses a high degree of smoothness at the knots in which the polynomial pieces connect. In certain implementations, one or more spline functions may be employed to produce composite Bezier curves that may be employed as segments that, when joined together, define a closed-loop mesh cutout border.

Example processing workflow may employ various visual distortion metrics for selecting the optimal or quasi-optimal mesh cutout. In an illustrative example, the visual distortion metric may reflect the difference of the image aspect ratios on the UV (two-dimensional) and polygonal mesh (three-dimensional) surfaces. In another illustrative example, the visual distortion metric may reflect the difference of distances between two arbitrary selected points on the UV (two-dimensional) and polygonal mesh (three-dimensional) surfaces.

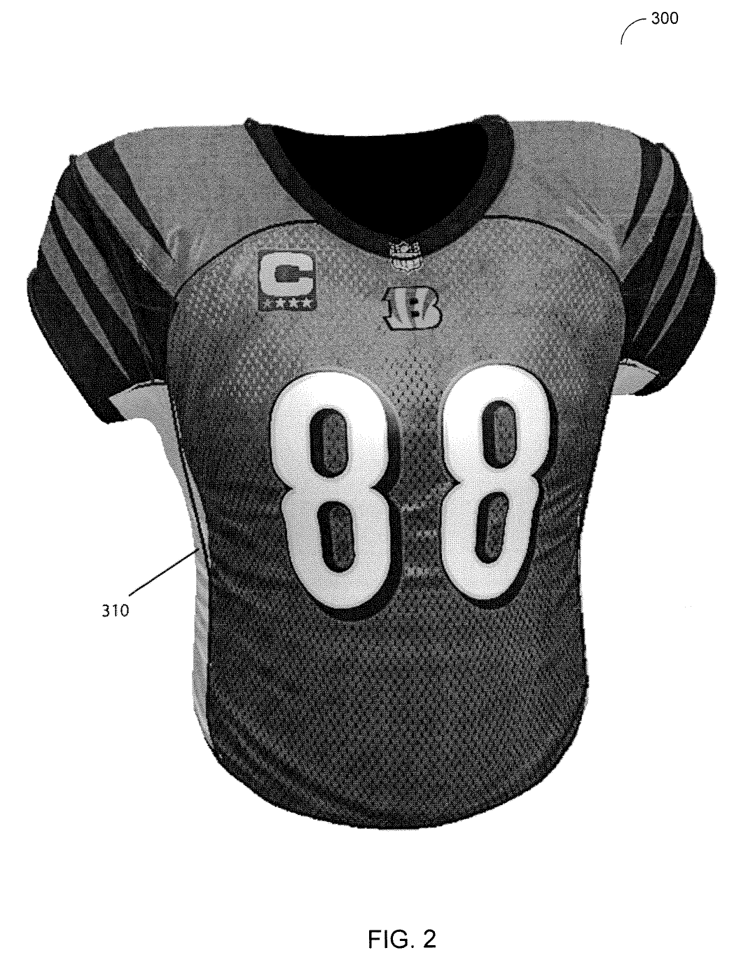

In certain implementations, the border of the mesh cutout may be chosen to follow a contour of a part of the real life object that is simulated by the three-dimensional mesh. As schematically illustrated by FIG. 3, border 310 of the mesh cutout may be chosen to follow the seam line of an item of a sports uniform 300, thus simulating the process of cutting and sewing several pieces of fabric into the uniform. Since in the real life each piece of the fabric is flat before being sewed together with other pieces of fabric, the mesh cutout having a border following the seam line of a clothing item would have an undistorted flat surface projection.

Referencing again FIG. 1, example processing workflow 100 outputs various visual objects that may be employed for creating three-dimensional computer-generated imagery representing, in the target application, a character equipped with a sports uniform. These visual objects may include one or more target application topology-compliant mesh cutouts 140A-140M representing the shapes of the respective uniform elements, and may further include various textures 150A-150Z, such as an albedo map, a normal map and/or an occlusion map, corresponding to the target application-resolution mesh cutouts. In certain implementations, the visual objects produced by example processing workflow 100 may be directly (i.e., without any further processing) used by the target application (such as an interactive video game). Alternatively, the visual objects produced by example processing workflow 100 may be edited by an artist for further improving certain visual aspects of those objects.

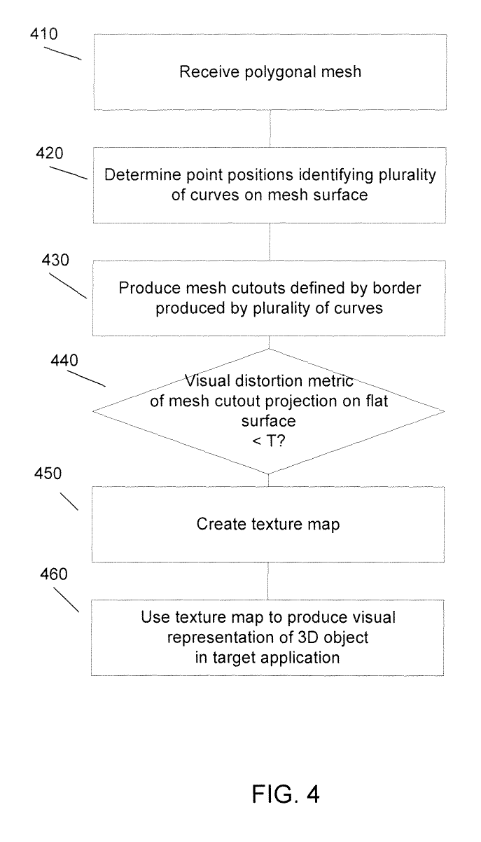

In various implementations, example processing workflow 100 may employ any combination of operations of example method 400 for creating texture maps for three-dimensional surfaces, which is described herein below with reference to FIG. 4.

In accordance with one or more aspects of the present disclosure, various dependency nodes may be defined in an example workflow for creating a set of visual objects associated with an interactive video game character. Such dependency nodes may include nodes to define cutout borders based on the input curves that may be received from other workflow nodes or specified by the user, implement mesh cutouts using the defined borders, etc.

In certain implementations, the input curves may be created by an interactive workflow component, which may receive, via a graphical user interface, positions of one or more points defining each curve. The workflow component may add a point, delete a point, move a specified point to a new location on the surface of the polygonal mesh, change the tangent at a specified point, or break the tangent at a specified point. The workflow component may use spline-based functions to produce a curve that includes the specified points. The workflow component may then join a plurality of curves into a closed loop line which defines the border of a mesh cutout.

Since the mesh cutouts and corresponding texture maps representing various elements of the sports uniform may be created and/or modified independently of one another, the dependency graph of such example workflow may reflect the corresponding creation/modification operation as being independent of one another, thus improving the overall workflow efficiency.

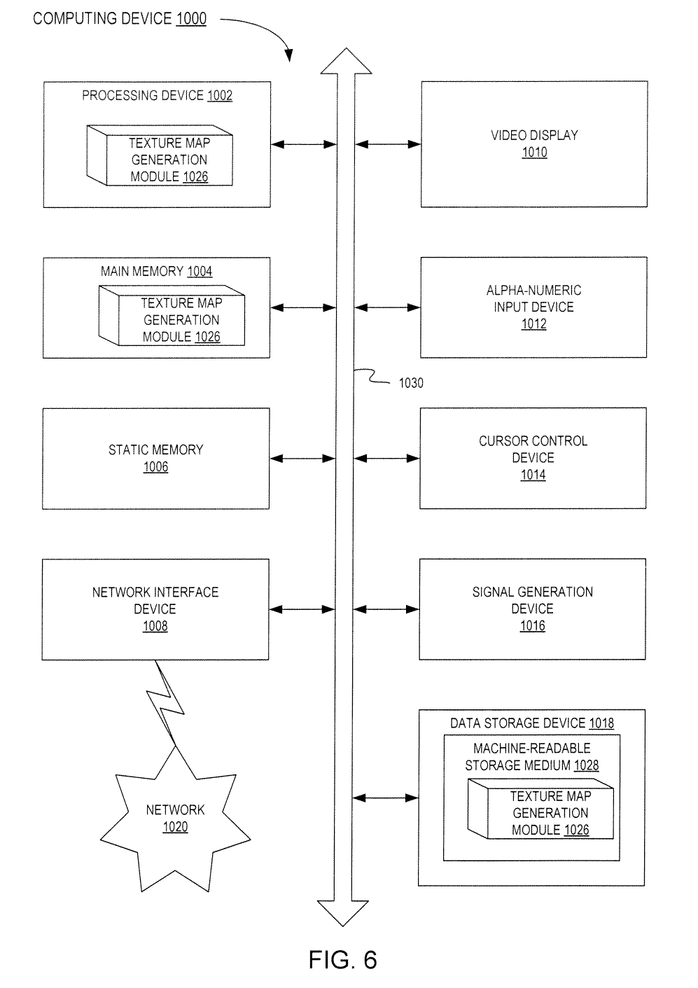

FIG. 4 depicts a flow diagram of an example method 400 for creating texture maps for three-dimensional surfaces, in accordance with one or more aspects of the present disclosure. Method 400 and/or each of its individual functions, routines, subroutines, or operations may be performed by one or more general purpose and/or specialized processing devices. Two or more functions, routines, subroutines, or operations of method 400 may be performed in parallel or in an order which may differ from the order described above. In certain implementations, method 400 may be performed by a single processing thread. Alternatively, method 400 may be performed by two or more processing threads, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processing threads implementing method 400 may be executed asynchronously with respect to each other. In an illustrative example, method 400 may be performed by computing device 1000 described herein below with references to FIG. 6.

At block 410, a processing device implementing the method may receive a polygonal mesh defining a shape of a three-dimensional object to be rendered in a target application (such as an interactive video-game), as described in more details herein above.

At block 420, the processing device may determine positions of points identifying a plurality of curves on a surface of the polygonal mesh. In an illustrative example, the processing device may receive the point co-ordinates via a graphical user interface. Alternative, the processing device may receive the point co-ordinates from another component of a workflow that creates a set of visual objects associated with an interactive video game character, as described in more details herein above.

At block 430, the processing device may produce a mesh cutout having a border defined by a closed loop line that includes the plurality of curves. In certain implementations, the border of the mesh cutout may be chosen to follow the seam line of an item of a sports uniform, thus simulating the process of cutting and sewing several pieces of fabric into the uniform. In various illustrative examples, the identified mesh cutout may represent a panel, a patch, a stripe, and/or a stich of a sports uniform, as described in more details herein above.

At block 440, the processing device may determine that a projection of the mesh cutout onto a flat surface produces a value of a visual distortion metric that does not exceed a defined distortion threshold. Example processing workflow may employ various visual distortion metric for selecting the optimal or quasi-optimal mesh cutout. In an illustrative example, the visual distortion metric may reflect the difference of the image aspect ratios on the UV (two-dimensional) and polygonal mesh (three-dimensional) surfaces. In another illustrative example, the visual distortion metric may reflect the difference of distances between two arbitrary selected points on the UV (two-dimensional) and polygonal mesh (three-dimensional) surfaces

Responsive to determining, at block 440, that the visual distortion metric that does not exceed the defined distortion threshold, the processing device may, at block 450, create a texture map by projecting a two-dimensional image onto a surface of the mesh cutout, as described in more details herein above.

At block 460, the processing device may employ the polygonal mesh to produce a visual representation of the three-dimensional object in the target application (e.g., an interactive video game), as described in more details herein above. Responsive to completing the operations described with reference to block 460, the method may terminate.

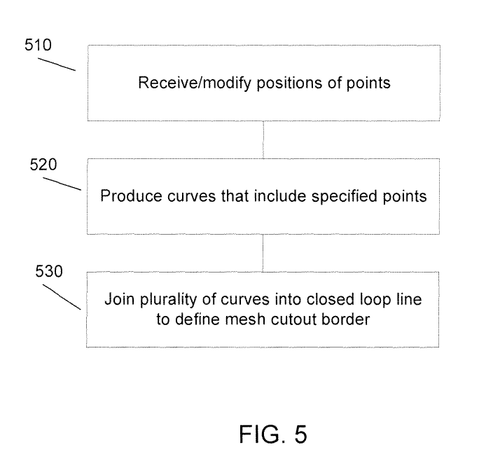

FIG. 5 depicts a flow diagram of an example method 500 for defining the border of a mesh cutout, in accordance with one or more aspects of the present disclosure. Method 500 and/or each of its individual functions, routines, subroutines, or operations may be performed by one or more general purpose and/or specialized processing devices. Two or more functions, routines, subroutines, or operations of method 500 may be performed in parallel or in an order which may differ from the order described above. In certain implementations, method 500 may be performed by a single processing thread. Alternatively, method 500 may be performed by two or more processing threads, each thread executing one or more individual functions, routines, subroutines, or operations of the method. In an illustrative example, the processing threads implementing method 500 may be synchronized (e.g., using semaphores, critical sections, and/or other thread synchronization mechanisms). Alternatively, the processing threads implementing method 500 may be executed asynchronously with respect to each other. In an illustrative example, method 500 may be performed by computing device 1000 described herein below with references to FIG. 6.

At block 510, a processing device implementing the method may receive, via a graphical user interface, positions of one or more points defining a plurality of curves. In various illustrative examples, responsive to receiving a user interface command, the processing device may add a point, delete a point, move a specified point to a new location on the surface of the polygonal mesh, change the tangent at a specified point, or break the tangent at a specified point, as described in more details herein above.

At block 520, the processing device may produce one or more curves that include the specified points. In certain implementations, the processing device may use spline-based functions to produce composite Bezier curves, as described in more details herein above.

At block 530, the processing device may join a plurality of curves into a closed loop line which defines the border of a mesh cutout, as described in more details herein above. Responsive to completing the operations described with reference to block 530, the method may terminate.

FIG. 6 illustrates a diagrammatic representation of a computing device 1000 which may implement the systems and methods described herein. Computing device 1000 may be connected to other computing devices in a LAN, an intranet, an extranet, and/or the Internet. The computing device may operate in the capacity of a server machine in client-server network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 1000 may include a processing device (e.g., a general purpose processor) 1002, a main memory 1004 (e.g., synchronous dynamic random access memory (DRAM), read-only memory (ROM)), a static memory 1006 (e.g., flash memory and a data storage device 1018), which may communicate with each other via a bus 1030.

Processing device 1002 may be provided by one or more general-purpose processing devices such as a microprocessor, central processing unit, or the like. In an illustrative example, processing device 1002 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 1002 may also comprise one or more special-purpose processing devices such as an application specific integrated circuit (ASIC), a field programmable gate array (FPGA), a digital signal processor (DSP), network processor, or the like. The processing device 1002 may be configured to execute texture map generation module 1026 implementing methods 400 and/or 500 for creating texture maps for three-dimensional surfaces, in accordance with one or more aspects of the present disclosure, for performing the operations and steps discussed herein.

Computing device 1000 may further include a network interface device 1008 which may communicate with a network 1020. The computing device 1000 also may include a video display unit 1010 (e.g., a liquid crystal display (LCD) or a cathode ray tube (CRT)), an alphanumeric input device 1012 (e.g., a keyboard), a cursor control device 1014 (e.g., a mouse) and an acoustic signal generation device 1016 (e.g., a speaker). In one embodiment, video display unit 1010, alphanumeric input device 1012, and cursor control device 1014 may be combined into a single component or device (e.g., an LCD touch screen).

Data storage device 1018 may include a computer-readable storage medium 1028 on which may be stored one or more sets of instructions, e.g., instructions of texture map generation module 1026 implementing methods 400 and/or 500 for creating texture maps for three-dimensional surfaces, in accordance with one or more aspects of the present disclosure. Instructions implementing module 1026 may also reside, completely or at least partially, within main memory 1004 and/or within processing device 1002 during execution thereof by computing device 1000, main memory 1004 and processing device 1002 also constituting computer-readable media. The instructions may further be transmitted or received over a network 1020 via network interface device 1008.

While computer-readable storage medium 1028 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “updating”, “identifying”, “determining”, “sending”, “assigning”, or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc. as used herein are meant as labels to distinguish among different elements and may not necessarily have an ordinal meaning according to their numerical designation.

Examples described herein also relate to an apparatus for performing the methods described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

What is claimed is:

1. A method, comprising:
receiving, by a processing device, a polygonal mesh defining a shape of a three-dimensional object to be rendered in a video-game;
determining positions of points identifying a plurality of curves on a surface of the polygonal mesh;
producing a mesh cutout having a border defined by a closed loop line comprising the plurality of curves;
determining that a projection of the mesh cutout onto a flat surface produces a value of a visual distortion metric that does not exceed a defined distortion threshold;
creating, by the processing device, a texture map by projecting a two-dimensional image onto a surface of the mesh cutout; and
using the texture map to produce a visual representation of the three-dimensional object in the video-game.

2. The method of claim 1, wherein the visual distortion metric reflects a difference of image aspect ratios on the flat surface and the polygonal mesh.

3. The method of claim 1, wherein the visual distortion metric reflects a difference of distances between two points on the flat surface and the polygonal mesh.

4. The method of claim 1, wherein the three-dimensional object represents a part of a human body.

5. The method of claim 1, wherein the border of the mesh cutout follows a seam line of an item of a sports uniform.

6. The method of claim 1, wherein the mesh cutout represents at least one of: a panel of a sports uniform item, a patch of a sports uniform item, a stripe of a sports uniform item, or a stich of a sports uniform item.

7. The method of claim 1, wherein the polygonal mesh represents a part of a vehicle body.

8. The method of claim 1, wherein the polygonal mesh represents a part of a body armor.

9. A method, comprising:
receiving, by a processing device, a polygonal mesh defining a shape of a three-dimensional object;
identifying a mesh cutout comprising a contiguous subset of faces of the polygonal mesh, wherein a projection of the mesh cutout onto a flat surface produces a value of a visual distortion metric not exceeding a defined distortion threshold; and
creating a texture map by projecting a two-dimensional image onto a surface of the mesh cutout.

10. The method of claim 9, further comprising: using the texture map to produce a visual representation of the three-dimensional object in a video-game.

11. The method of claim 9, wherein identifying a mesh cutout comprises defining a border of the mesh cutout using a plurality of spline-based functions.

12. The method of claim 9, wherein the visual distortion metric reflects a difference of image aspect ratios on the flat surface and the polygonal mesh.

13. The method of claim 9, wherein the visual distortion metric reflects a difference of distances between two points on the flat surface and the polygonal mesh.

14. The method of claim 9, wherein the three-dimensional object represents a part of a human body.

15. The method of claim 9, further comprising:
using the texture map to produce a visual representation of a human being wearing a sports uniform.

16. The method of claim 9, wherein a border of the mesh cutout follows a seam line of an item of a sports uniform.

17. The method of claim 9, wherein the mesh cutout represents at least one of: a panel of a sports uniform item, a patch of a sports uniform item, a stripe of a sports uniform item, or a stich of a sports uniform item.

18. The method of claim 9, further comprising:
using the texture map to produce a visual representation of at least one of: a part of a vehicle body or a part of a body armor.

19. A computer-readable non-transitory storage medium comprising executable instructions to cause a processing device to:
receive, by the processing device, a polygonal mesh comprising a plurality of polygonal faces, the polygonal mesh defining a shape of a three-dimensional object;
identify a mesh cutout comprising a contiguous subset of the polygonal mesh, wherein a projection of the mesh cutout onto a flat surface produces a value of a visual distortion metric not exceeding a defined distortion threshold;
create, by the processing device, a texture map by projecting a two-dimensional image onto a surface of the mesh cutout; and
use the texture map to produce a visual representation of the three-dimensional object in a video-game.

20. The computer-readable non-transitory storage medium of claim 19, wherein executable instructions causing the processing device to identify the mesh cutout further comprise executable instructions causing the processing device to define a border of the mesh cutout using a plurality of spline-based functions
